(19) United States
(12) Patent Application Publication
(10) Pub. No.: US 2017/0218310 A1
(43) Pub. Date: Aug. 3, 2017

(54) Laundry Scent Booster

(71) Applicant: Colgate-Palmolive Company, New York, NY (US)

(72) Inventors: Charles John Schramm, JR., Hillsborough, NJ (US); Katie TRUONG, Piscataway, NJ (US)

(73) Assignee: Colgate-Palmolive Company, New York, NY (US)

(21) Appl. No.: 15/500,301

(22) PCT Filed: Jul. 30, 2014
(86) PCT No.: PCT/US2014/048759

§ 371 Date: Jan. 30, 2017

(51) Int. Cl. C11D 3/50; C11D 3/04; C11D 3/10

(52) U.S. Cl. CPC C11D 3/505; C11D 3/10; C11D 3/046

(57) ABSTRACT

A fragrance-providing composition comprising particles of at least one of porous sodium sulfate and porous sodium carbonate, wherein the particles have a porosity of 0.4-0.6 and are entrained with fragrance oil. Also provided are laundry compositions comprising the entrained porous particles in combination with one or more laundry additives.

### BACKGROUND

In textile washing or laundry products, such as fabric softeners or detergents, generally fragrance oils or perfumes are present which make the products more aesthetically pleasing to consumers. The perfumes can be delivered through the rinse cycle of a washing machine or be present in dryer sheets and other forms. The product containing the perfume should not only smell pleasantly and in that way add to the purchase perception, but also impart a pleasant and preferably long lasting fragrance to the fibers or fabrics treated therewith.

A common practice in the art is the admixing of the free fragrance oil directly into the product, e.g., fabric softener, detergent, and the like. However, there are several drawbacks to this simple approach. The fragrance oils are volatile, resulting in fragrance loss during manufacturing, storage, and use. Many fragrance oils are also unstable over time. This again results in loss during storage. Another problem in the art is that the amount of fragrance carryover is rather marginal; i.e., much fragrance is lost during washing and is not deposited on the fabrics.

Various methods to solve these problems have been employed in the art. One approach is to encapsulate the fragrance oils. However, encapsulation can be costly.

Another approach is using solid carriers for fragrance oils. Carrier materials can be of organic or inorganic nature, such as, for example, starches, silicic acids, phosphates, zeolites, alkali salts of polycarboxylic acids, cyclodextrins, etc., sometimes formulated with further additives in addition to the fragrance oil. One of the problems with using carriers is that the loading or concentration of the fragrance oil can be limited, thereby imparting insufficient or less than optimal amounts of fragrance oil to the laundry product in a stable form that will be available for fabric deposition.

Sodium sulfate and sodium carbonate cart be used as carriers for fragrance oils. However, the form of sodium sulfate and sodium carbonate known in the an as fragrance oil carriers sometimes provides for less than optimal fragrance oil loading.

There is an ongoing need for improving fragrance oil loading capability on carriers, improving fragrance oil stability, improving fragrance oil delivery to or deposition on fabrics such as cotton, and for achieving the fragrance effect for a longer period of time.

### BRIEF SUMMARY

It has now been found that porous forms of sodium sulfate, sodium carbonate or a mixture thereof allows much higher loading of fragrance oil than non-porous forms. Disclosed is a fragrance-providing composition comprising particles of at least one of porous sodium sulfate and porous sodium carbonate, wherein the particles have a porosity of 0.4-0.6 and are entrained with fragrance oil. The entrained particles can have a high concentration of fragrance oil, e.g., up to 20%.

The entrained particles typically are in the form of a lice flowing powder, are readily pourable and do not clump.

The composition typically results in an intensive fragrance experience for the consumer, for example when washing laundry with a detergent formulation or using a fabric softener that contains the fragrance-providing composition. A fragrance-intensifying effect is achieved, which affects the particles directly as well as products into which the entrained particles are incorporated, for example detergent formulations, as well as objects such as, for example, textiles that are treated with the products.

A further advantage of the particles is that the scent impression resulting from the particles persists, indirectly and directly, for longer. “Directly” means in this connection that the particles as such are fragrant over a longer period of time. “Indirectly” means in this connection that objects (e.g. a detergent formulation) that contain the particles are fragrant for longer, and that in fact when products, e.g. a detergent formulation for washing textiles, are used, the objects, e.g., a washed textile, treated therewith are fragrant for longer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

A fragrance-providing composition, which comprises entrained porous particles. Such compositions are sometimes referred to as laundry scent boosters. In addition, laundry compositions, such as fabric softeners, fabric refreshers, detergents in a form of liquid, powder, gel or a composition applied onto a fabric substrate such as fabric softener sheets and/or wipes, comprising the entrained porous particles in combination with one or more laundry additives.

Sodium sulfate is the sodium salt of sulfuric acid. When anhydrous, it is a white crystalline solid of formula Na₂SO₄ known as the mineral thenardite; the decahydrate Na₂SO₄.10H₂O is found naturally as the mineral mirabilite, and in processed form has been known as Glauber's salt or, historically, sal mirabilis.

Sodium sulfate has unusual solubility characteristics in water. Its solubility in water rises more than tenfold between 0° C. to about 32.4° C., where it reaches a maximum of 497 g/L. At this point, the solubility curve changes slope, and the solubility becomes almost independent of temperature. The temperature of about 32.4° C., corresponds to the release of crystal water and melting point of the hydrated salt. Sodium sulfate decahydrate can be crystallized from an aqueous solution using conventional crystallization techniques known in the art. To form sodium sulfate decahydrate crystals, the crystallization should be performed below 0° C., e.g., about −20° C. to about −1° C., in one embodiment about −5° C. Excess water can be removed from the crystals by conventional procedures, e.g., filtration.

It has been discovered that when sodium sulfate decahydrate crystals are air dried under suitable conditions, including drying below the crystals' melting point, i.e., below about 32.4° C., in one embodiment about 20° C. to about 30° C., a free flowing powder results comprising particles having a porous structure. The pores or voids of the particles are present due to the water molecules that formerly occupied the pores or voids prior to evaporation of the water. Other suitable conditions include air drying for a time sufficient to result in the water of the crystals to evaporate, e.g., for about 8 to about 12 hours, in one embodiment about 12 to about 24 hours, at a temperature of about 25° C. to about 30° C., in one embodiment about 20° C. to about 25° C. Porous sodium sulfate refers to sodium sulfate having a porosity of 0.4 to 0.6.

Sodium carbonate crystallizes from water to form three different hydrates sodium carbonate decahydrate (natron), sodium carbonate heptahydrate (not known in mineral form), and sodium carbonate monohydrate (thermonatrite).

Sodium carbonate decahydrate/sodium carbonate heptahydrate mixtures can be crystallized from an aqueous solution using conventional crystallization techniques known in the art. To form sodium carbonate decahydrate sodium carbonate heptahydrate mixture crystals, the crystallization should be performed below 20° C., e.g., about −5° C. to about 20° C., in one embodiment about −5° C. Excess water can be removed from the crystals by conventional procedures, e.g., filtration.

Similar to sodium sulfate decahydrate, it has been discovered that when sodium carbonate decahydrate crystals or sodium carbonate heptahydrate crystals are air dried under suitable conditions, including drying below the crystals' melting point, i.e., below about 32° C., in one embodiment about 20° C. to about 30° C. for sodium carbonate decahydrate and below about 33.5° C., in one embodiment about 20° C. to about 30° C. for sodium carbonate heptaahydrate, a free flowing powder results comprising particles having a porous structure. The pores or voids of the particles are present do to the water molecules that formerly occupied the pores or voids prior to evaporation of the water. Other suitable conditions are the same as for drying the sodium sulfate decahydrate crystals, e.g., air drying for a time sufficient to result in the water of the crystals to evaporate, e.g., for about 8 to about 12 hours, in one embodiment about 12 to about 24 hours, at a temperature of about 25° C. to about 30° C., in one embodiment about 20° C. to about 25° C. Porous sodium carbonate refers to sodium carbonate having a porosity of 0.4 to 0.6.

Porosity is measured using a Quantachrome Autoscan 60 over a range of 0 to 4.1×10⁷ Pa (0 to 6000 psi) by mercury porosimitry, intrusion and extrusion at a contact angle of 140°. Samples are placed into the scanner at room temperature (23° C.).

In certain embodiments, the amount of porous sodium sulfate is 20 to 35% by weight of the composition. In other embodiments, the amount of porous sodium sulfate is 23 to 27%, 24 to 26%, or 25% by weight of the composition.

In certain embodiments, the amount of porous sodium carbonate is 20 to 35% by weight of the composition. In other embodiments, the amount of porous carbonate sulfate is 23 to 27%, 24 to 26%, or 25% by weight of the composition.

The porous particles are entrained with fragrance oil. By “entrained” is meant that the porous particles are contacted with fragrance oil under conditions to result in substantially complete adsorption/absorption of the oil on and into the porous particles, including filling or substantially filling the voids or pores previously occupied by water molecules, with the fragrance oil. In addition, the surfaces of the particles are coated with the fragrance oil, similar to using non-porous particles as a carrier. By using the porous particles of the invention a high concentration or loading of fragrance oil can be achieved, e.g. up to about 20%. Thus, in one embodiment the fragrance-providing composition of the invention comprise about 5% to about 20%, fragrance oil and about 80% to about 95% porous carrier, by weight. In one embodiment the fragrance-providing composition comprises about 10% to about 20% fragrance oil and about 80% to about 90% porous carrier, by weight.

To entrain the fragrance oil inion the porous carrier, the porous sodium sulfate, porous sodium carbonate or mixture thereof is mixed with the desired amount of fragrance oil with mild agitation at about 20° C. to about 3.5° C., in one embodiment about 23° C., for a time sufficient to result in complete imbibing, adsorption and/or absorption of the oil in/on the porous particles, typically for at least about 30 minutes, in one embodiment at least about 1 hour.

In addition to the fragrance oil of the entrained particles, additional fragrance can be present in the laundry compositions in free form, encapsulated, or both.

The term “perfume” or “fragrance oil” as used herein refers to odoriferous materials which are able to provide a pleasing fragrance to fabrics, and encompasses conventional materials commonly used in fabric softeners or detergent compositions to counteract a malodor in such compositions and/or provide a pleasing fragrance thereto. The perfumes are preferably in the liquid state at ambient temperature. The fragrance oils for use in this invention may be selected from any suitable fragrance known to the an. It is a characteristic of this invention that an unusually broad range of fragrance oils ma be used. Included among the perfumes contemplated for use herein are materials such as aldehydes, ketones, esters and the like which are conventionally employed to impart a pleasing fragrance to fabric softeners as well as liquid and granular detergent compositions. Naturally occurring plant and animal oils are also commonly used as components of perfumes. Accordingly, the perfumes useful for the present invention may have relatively simple compositions or may comprise complex mixtures of natural and synthetic chemical components, all of which are intended to provide a pleasant odor or fragrance when applied to fabrics. The perfumes used in laundry compositions are generally selected to meet normal requirements of odor, stability, price and commercial availability.

Individual odorant compounds, e.g. the synthetic products of the ester, ether, aldehyde, ketone, alcohol, and hydrocarbon types, can be used as fragrance oils or perfumes. Odorant compounds of the ester type are, for example, benzyl acetate, phenoxyethyl isobutyrate, p-tert.-butyl cyclohexyl acetate, linalyl acetate, dimethyl benzyl carbinyl acetate (DMBCA), phenyl ethyl acetate, benzyl acetate, ethyl methyl phenyl glycinate, allyl cyclohexyl propionate, styrallyl propionate, benzyl salicylate, cyclohexyl salicylate, floramate, melusate, and jasmecyclate. The ethers include, for example, benzyl ethyl ether and ambroxan; the aldehydes, for example, the linear alkanals having 8 to 18 carbon atoms, citral, citronellal, citronellyl oxyacetaldehyde, cyclamenaldehyde, lilial and bourgeonal; the ketones, for example, the ionones, α-isomethyl ionone und methyl cedryl ketone; the alcohols, anethol, citronellol, eugenol, geraniol, linalool, phenylethyl alcohol and terpineol; and the hydrocarbons include principally the terpenes such as limonene and pinene. Preferably, however, mixtures of different odorants that together produce an attractive fragrance note are used.

Fragrance oils can also contain natural odorant mixtures such as those accessible from plant sources, for example pine, citrus, jasmine, patchouli, rose, or ylang-ylang oil. Also suitable are muscatel, salvia oil, chamomile oil, dove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil.

Specific examples of fragrance oils include digeranyl succinate, dineryl succinate, geranyl neryl succinate, phenylacetate, neryl phenylacetate, geranyl laurate, neryl laurate, di(b-citronellyl) maleate, dinonadol maleate, diphenoxyanol maleate, di(3,7-dimethyl-1-octanyl) succinate, di(cyclohexylethyl) maleate, diflralyl succinate, di(phenylethyl) adipate, 7-acryl-1,2,3,4,5,6,7,8-octahydro-1,1,6,7-tetramethyl naphthalene, ionone methyl, ionone gamma methyl, methyl cedrylone, methyl dihydrojasmonate, methyl 1,6,10-trimethyl-2,5,9-cyclododecatrien-1-yl ketone, 7-acetyl-1,1,3,4,4,6-hexamethyl tetralin, 4-acetyl-6-tert-butyl-1,1-dimethyl indane, para-hydroxy-phenyl-butanone, benzophenone, methyl beta-naphthyl ketone, 6-acetyl-1,1,2,3,3,5 hexamethyl indane, 5-acetyl-3-isopropyl-1,1,2,6-tetramethyl indane, dodecanal, 4-(4-hydroxy-4-methylpentyl)-3-cyclohexene-1-carboxaldehyde, 7-hydroxy-3,7-dimethyl ocatanal, 10-undecen-1-al, isohexenyl cyclohexyl carboxaldehyde, formyl tricyclodecane, condensation products of hydroxycitronellal and methyl anthranilate condensation products of hydroxycitronellal and indol, condensation products of phenyl acetaldehyde and indol. 2-methyl-3-(para-tert-butylphenyl)-propionaldehyde, ethyl vanillin, heliotropin, hexyl cinnamic aldehyde, amyl cinnamic aldehyde, 2-methyl-2-(para-iso-propylphenyl)propionaldehyde, coumarin, decalactone gamma, cyclopentadecanolide, 16-hydroxy-9-hexadecenoic acid lactone, 13,4,6,7,8-hexahydro-4,6,6,7,8,8-hexamethylcyclo-penta-gamma-2-benzopyrane, beta-naphthol methyl ether, ambroxane, dodecahydro-3a,6,6,9a-tetramethylnaphtho[2,1b]furan, cedrol, 5-(2,2,3-trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate cedryl acetate, para-(tert-butyl)cyclohexyl acetate, essential oils, resinoids, and resins from a variety of sources including but not limited to orange oil, lemon oil, patchouli, Peru balsam, Olibanum resinoid, styrax, labdanum resin, nutmeg, cassia oil, benzoin resin, coriander, lavandin, and lavender, phenyl ethyl alcohol, terpineol, linalool, linalyl acetate, geraniol, nerol, 2-(1,1-dimethylethyl)cyclohexanol acetate, benzyl acetate, orange terpenes, eugenol, diethylphthalate, and combinations thereof.

The particle size of the entrained porous particles is typically in the range of 0.6 to 30 mm, particularly from 0.8 to 7 mm, and more typically from 1. to 3 mm.

Also provided are laundry compositions such as detergents, fabric softeners and the like, that contain the fragrance-providing compositions, i.e., entrained porous particles, in combination with one or more laundry additives. In the laundry composition, the entrained porous carrier typically comprises 5% to 30% by weight, in one embodiment 10% to 25% by weight, in another embodiment 15% to 20%, by weight; and the laundry additivets) comprises 70% to 100% , in one embodiment 80% to 100% . in another embodiment 90% to 100%, by weight.

Laundry additives can be any material that can be added to laundry compositions. Examples of materials include, but are not limited to, surfactants, thickeners, polymers, colorants, clays, buffers, silicones, fatty alcohols, and fatty esters. Other laundry additives include bleaching agents, bleach activators, enzymes silicone oils, anti-redeposition agents, optical brighteners, graying inhibitors, shrink inhibitors, anti-creasing agents, builder materials, fillers, diluents, chelating compounds, skin care compounds, color transfer inhibitors, antimicrobials, germicides, fungicides, antioxidants, antistats, ironing aids, water proofing agents, impregnation agents, swelling agents, anti-slip agents, UV absorbers. The laundry compositions, can contain mixtures of two or more additives.

The laundry compositions may contain one or a mixture of surfactants chosen from anionic, cationic and nonionic surfactants.

The use of polysiloxanes and/or cationic polymers as laundry additives is desirable in that they not only show a softening effect, but also reinforce the impression of the perfume of the laundry. The use of softening clays as a laundry additive in the present invention is also desirable in that they show a water-softening effect, thus mitigating lime scale deposits on the laundry.

Other components may be present in the detergent compositions to improve the properties and in some cases, to act as diluents or fillers. Illustrative of suitable additives are enzymes to further promote cleaning of certain hard to remove stains from laundry. Among enzymes, the proteolytic and amylolytic enzymes are most useful. Other useful adjuvants are foaming agents when foam is desired, and anti-foams, when desired. Also useful are polymers, anti-redeposition agents, bleaches, fluorescent brighteners, and colorants such as dyes and pigments, clays, silicones fatty alcohols, fatty esters and the like may optionally be added.

If desired, the fragrance oil can also be combined with a perfume fixative. It is assumed that perfume fixatives can delay the evaporation of the more-volatile components of perfumes.

A perfume fixative can be in the form of diethyl phthalates, musk (derivatives), and mixtures thereof, the quantity of fixative being by preference 1 to 55 weight %, advantageously 2 to 50 weight %, even more advantageously 10 to 45 weight %, in particular 20 to 40 weight % of the entire quantity of perfume.

The laundry compositions described herein may be in the form of a liquid, powder or gel as well as a fabric softener sheet.

The laundry compositions optionally may comprise a free perfume and or at perfume microcapsule.

In one embodiment, the laundry composition comprises free (neat) fragrance oil in addition to the entrained porous carrier of the invention. In such an embodiment, the laundry composition may comprise less than about 20%, alternatively less than about 25%, alternatively from about 1% to about 20%, alternatively from about 1% to about 10%, alternatively from about 3% to about 8% of free fragrance oil by weight of the laundry composition.

The laundry compositions of the present invention optionally can comprise fragrance oil encapsulated in a perfume microcapsule (PMC) in addition to the entrained porous carrier. in such an embodiment, the composition may comprise from 1% to 10%, alternatively from 2% to 12%, alternatively from 2% to 8%, alternatively from 3% to 8%, alternatively from 4% to 7%, alternatively from 5% to 7%, alternatively combinations thereof, of PMC (including the encapsulated perfume) by weight of the composition. In this embodiment, the perfume encapsulated by the PMC may comprise from 0.6% to 4% of perfume by weight of the composition.

The laundry composition may comprise dye. The dye may include those that are typically used in laundry detergent or fabric softeners. The composition may comprises from about 0.001% to about 0.1%, alternatively from about 0.01% to about 0.02%, alternatively combinations thereof, of dye by weight of the composition.

Provided is, in a first embodiment a (Composition 1), a fragrance-providing composition comprising particles having a porosity of 0.4-0.6 comprising at least one of porous sodium sulfate and porous sodium carbonate, wherein the particles are entrained with fragrance oil, e.g.,
1.1 Composition 1, wherein the composition contains the porous sodium sulfate and the porous sodium carbonate;
1.2. Any foregoing composition, wherein an amount of porous soditun sulfate is 20 to 35% by weight of the composition;
1.3. Composition 1.2, wherein the amount of porous sodium sulfate is 23 to 27, 24 to 26, or 25% by weight of the composition;
1.4. Any foregoing composition, wherein an amount of porous sodium carbonate is 20 to 35% by weight of the composition;
1.5. Composition 1.4, wherein the amount of porous sodium carbonate is 23 to 27, 24 to 26, or 25% by weight of the composition;
1.6. Any foregoing composition, wherein the porosity is 0.5-0.6.
1.7. Any foregoing composition comprising 5% to 20%, fragrance oil and 80% to 95% porous carrier, or 10% to 20% fragrance oil and 80% to 90% porous carrier, by weight;
1.8. Any tbregoing composition herein the porous sodium sulfate is prepared by crystallizing sodium sulfite decahydrate crystals and air drying the crystals;
1.9. Any foregoing composition wherein the porous sodium carbonate is prepared by crystallizing sodium carbonate heptahydrate, sodium carbonate decahydrate, or a mixture thereof and air drying the crystals;
1.10. Any foregoing composition wherein fragrance oil is selected from digeranyl succinate, dineryl succinate, geranyl neryl succinate, geranyl phenylacetate, neryl phenylacetate, geranyl laurate, neryl laurate, di(b-citronellyl) maleate, dinonadol maleate, diphenoxyanol maleate, di(3,7-dimethyl-1-octanyl) succinate, di(cyclohexylethyl) maleate, diflralyl succinate, di(phenylethyl) adipate, 7-acetyl-1,2,3,4,5,6,7,8-octahydro-1,1,6,7-tetramethyl naphthalene, ionone methyl, ionone gamma methyl, methyl cedrylone, methyl dihydrojasmonate, methyl 1,6,10-trimethyl-2,5,9-cyclododecatrien-1-yl ketone, 7-acetyl-1,1,3,4,4,6-hexamethyl tetralin, 4-acetyl-6-tert-butyl-1,1-dimethyl indane, para-hydroxy-phenyl-butanone, benzophenone, methyl beta-naphthyl ketone, 6-acetyl-1,1,2,3,3,5 hexamethyl indane, 5-acetyl-3-isopropyl-1,1,2,6-tetramethyl indane, 1-dodecanal, 4-(4-hydroxy-4-methylpentyl)-3-cyclohexene-1-carboxaldehyde, 7-hydroxy-3,7-dimethyl ocatanal, 10-undecen-1-al, isohexenyl cyclohexyl carboxaldehyde, formyl tricyclodecane, condensation products of hydroxycitronellal and methyl anthranilate, condensation products of hydroxycitronellal and indol, condensation products of phenyl acetaldehyde and indol, 2-methyl-3-(para-tert-butylphenyl)-propionaldehyde, ethyl vanillin, heliotropin, hexyl cinnamic aldehyde, amyl cinnamic aldehyde, 2-methyl-2-(para-iso-propylphenyl)propionaldehyde, coumarin, decalactone gamma, cyclopentadecanolide, 16-hydroxy-9-hexadecenoic acid lactone, 1,3,4,6,7,8-hexahydro-4,6,6,7,8,8-hexamethylcyclo-penta-gamma-2-benzopyrane, beta-naphthol methyl ether, ambroxane, dodecahydro-3a,6,6,9a-tetramethylnaphtho[2,1b]furan, cedrol, trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate, cedryl acetate, para-(tent-butyl)cyclohexyl acetate, essential oils, resinoids, and, resins from a variety of sources including but not limited to orange oil, lemon oil, patchouli, Peru balsam, Olibanum resinoid, styrax, labdanum resin, nutmeg, cassia oil, benzoin resin, coriander, lavandin, and lavender, phenyl ethyl alcohol, terpineol, linalool, linalyl acetate, geraniol, nerol, 2-(1,1-dimethylethyl)cyclohexanol acetate, benzyl acetate, orange terpenes, eugenol, diethylphthalate and combinations thereof;
1.11. A laundry composition, such as a fabric softener, fabric refresher, detergent in a form of liquid, powder, gel or a composition applied onto a fabric substrate such as fabric softener sheets and/or wipes, comprising the entrained porous particles of any foregoing composition in combination with one or more laundry additives;
1.12. Composition 1.11 wherein the entrained porous carrier typically comprises 5% to 30% by weight, or 10% to 25% by weight, or 15% to 30%, by weight; and the laundry additive(s) comprises 70% to 100% , or 80% to 100%, or 90% to 100%, by weight;
1.13. Composition 1.11 or 1.12 wherein the laundry additive is selected from surthrtants, thickeners, polymers, colorants, clays, buffers, silicones, fatty alcohols, fatty esters, bleaching agents, bleach activators, enzymes, silicone oils, anti-redeposition agents, optical brighteners, graying inhibitors, shrink inhibitors, anti-creasing agents, builder materials, fillers, diluents, chelating compounds, skin care compounds, color transfer inhibitors, antimicrobials, germicides, fungicides, antioxidants, antistats, ironing aids, water proofing agents, impregnation agents, swelling agents, anti-slip agents, UV absorbers and mixtures thereof;
1.14. Compositions 1.11-1.13 wherein the additive comprises a filler which comprises one or more silicas;
1.15. Compositions 1.11-1.14 wherein the additive comprises one or more anionic, cationic and nonionic surfactants;
1.16. Compositions 1.11-1.15 further comprising free fragrance oil, encapsulated fragrance oil, or a mixture thereof.

Use of any of compositions 1 to 1.10 during laundering to deliver fragrance to fabric.

The following description of the preferred embodiment(s) is merely exemplary in nature and is in no way intended to limit the invention, its application, or uses.

### EXAMPLES

### Example 1

Porous sodium sulfate porous sodium carbonate, light soda ash, and spray dried sodium sulfate are tested for porosity. Data is in Table 1 below.

TABLE 1

| | Porosity | % > 250 nm | Pososity > 250 nm |
|---|---|---|---|
| Porous Sodium Sulfate | 0.57 | 99% | 0.56 |
| Porous Sodium Carbonate | 0.52 | 95% | 0.49 |
| Light soda ash (powdered) | 0.12 | 83% | 0.10 |
| Spray Dried Sodium Sulfate | 0.09 | 95% | 0.08 |

The increase in porosity allows for higher loading of fragrance in the porous sodium sulfate and porous sodium carbonate as compared to the light soda ash and spray dried sodium sulfate.

What is claimed is:

1. A fragrance-providing composition comprising particles of at least one of porous sodium sulfate and porous sodium carbonate, wherein the particles have a porosity of 0.4-0.6 and are entrained with fragrance oil.

2. The composition of claim 1, wherein the composition contains the porous sodium sulfate and the porous sodium carbonate.

3. The composition of any preceding claim 1, wherein an amount of porous sodium sulfate is 20 to 35% by weight of the composition.

4. The composition of claim 3, wherein the amount of porous sodium sulfate is 23 to 27, 24 to 26, or 25% by weight of the composition.

5. The composition of any preceding claim 1, wherein an amount of porous sodium carbonate is 20 to 35% by weight of the composition.

6. The composition of claim 5, wherein the amount of porous sodium carbonate is 23 to 27, 24 to 26, or 25% by weight of the composition.

7. The composition of any foregoing claim 1, wherein the porosity is 0.5-0.6.

8. The composition of any foregoing claim 1 comprising 5% to 20% fragrance oil and 80% to 95% particles by weight of the composition.

9. The composition of any foregoing claim 1 wherein the porous sodium sulfate is prepared by crystallizing sodium sulfate decahydrate crystals and air drying the crystals.

10. The composition of any foregoing claim 1 wherein the porous sodium carbonate is prepared by crystallizing sodium carbonate heptahydrate, sodium carbonate decahydrate, or a mixture thereof and air drying the crystals.

11. The composition of any foregoing claim 1 further comprising an encapsulated fragrance.

12. A laundry composition in the form of one of a fabric softener;
fabric refresher; detergent comprising the entrained porous particles of claim 1 in combination with one or more laundry additives.

13. The laundry composition of claim 12, wherein the entrained porous carrier comprises 5% to 30% by weight of the laundry composition.

14. The composition of claim 12 further comprising free fragrance oil, encapsulated fragrance oil, or a mixture thereof.

15. (canceled)
